(19) United States
(12) Patent Application Publication
(10) Pub. No.: US 2026/0281383 A1
(43) Pub. Date: Sep. 17, 2026

(54) METHODS AND APPARATUS FOR HYBRID INTRA/INTER COMPRESSION SCHEME FOR POINT CLOUD ATTRIBUTES

(71) Applicant: InterDigital CE Patent Holdings, SAS, Paris (FR)

(72) Inventors: Bertrand CHUPEAU, RENNES (FR); Gustavo SANDRI, CESSON SEVIGNE (FR); Franck THUDOR, RENNES (FR)

(21) Appl. No.: 19/474,588

(22) PCT Filed: Apr. 5, 2024
(86) PCT No.: PCT/EP2024/059316

§ 371 Date: Oct. 10, 2025

(30) Foreign Application Priority Data
Apr. 12, 2023 (EP) 23305539.1

(51) Int. Cl. H04N 19/159; H04N 19/103; H04N 19/13; H04N 19/176; H04N 19/51; H04N 19/593; H04N 19/597; H04N 19/96

(52) U.S. Cl. CPC H04N 19/159; H04N 19/103; H04N 19/13; H04N 19/176; H04N 19/51; H04N 19/593; H04N 19/597; H04N 19/96

(57) ABSTRACT

Methods and devices for encoding and decoding a sequence of dense point clouds are disclosed. The described compression scheme of dense point cloud sequences takes advantage of the temporal redundancy between successive point cloud frames in a sequence of dynamic point clouds to achieve enhanced compression performance for point cloud rendering attributes. Also, in a dynamic point cloud, not all object parts can be predicted from the previous point cloud frame. Some parts are more efficiently predicted in an intra mode, that is from already decoded parts of the current point cloud frame, either at a coarser resolution or from a causal decoding neighbourhood. According to the present principles, a hybrid intra/inter compression scheme is set.

### CROSS REFERENCE TO RELATED APPLICATIONS

This application claims the benefit of European Application No. 23305539.1, filed on Apr. 12, 2023, which is incorporated herein by reference in its entirety.

### 1. TECHNICAL FIELD

The present principles generally relate to the domain of compression of a point cloud comprising attribute data. The present document is also understood in the context of the encoding, the formatting and the decoding of data representative of a point cloud for example for a rendering of volumetric content on end-user devices such as mobile devices or Head-Mounted Displays (HMD). In particular, the present document relates to a hybrid intra/inter compression scheme for attribute values of a point cloud.

### 2. BACKGROUND

The present section is intended to introduce the reader to various aspects of art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art.

Advances in 3D (three-dimensional) capturing and rendering technologies are enabling new applications and services in the fields of autonomous driving, cultural heritage archival, immersive telepresence and virtual/augmented reality. Point clouds have arisen as one of the main 3D scene representations for such applications. A point cloud frame consists of a set of 3D points, each point being represented by its 3D position and possibly several rendering attributes such as color, transparency, reflectance, normal vector, etc. Points clouds may be dynamic. A sequence of temporally successive points clouds is captured. Each point cloud is then a frame of the sequence and is rendered according to a timestamp within the sequence. The compression of dynamic point clouds is a technical challenge as the amount of data is huge. A combination of tools may be used to perform the compression of a sequence of point clouds, for example a combination of octree+triangle soups for geometry coding, motion compensated inter-frame prediction of geometry (octree and triangle soup), context-adaptive arithmetic coding of octree and triangle soup, and Region-Adaptive Hierarchical Transform (RAHT) for intra-frame colour coding.

A point cloud encoding scheme combining such tools leverages the spatial (intra-frame) and temporal (inter-frame) redundancies. For rendering attributes, however, only intra-frame redundancies are removed. There is a lack for adding a temporal prediction of rendering attributes, taking into account the motion in between two successive point cloud frames, to reach better compression rates. Combining intra-frame and inter-frame prediction in a compression scheme for point cloud rendering attributes yields a hybrid compression scheme, based on the paradigm comparable to motion-compensated hybrid 2D video codecs.

### 3. SUMMARY

The following presents a simplified summary of the present principles to provide a basic understanding of some aspects of the present principles. This summary is not an extensive overview of the present principles. It is not intended to identify key or critical elements of the present principles. The following summary merely presents some aspects of the present principles in a simplified form as a prelude to the more detailed description provided below.

The present principles relate to a method for encoding a sequence of point clouds. A point cloud of the sequence comprises a geometry and rendering attributes. The method comprises, for a current frame, obtaining a temporal prediction of current point cloud by motion-compensating the geometry and the rendering attributes of a previous frame of the sequence. The geometry of current point cloud is compressed, and the compressed geometry is encoded in the data stream. Then, a temporary point cloud is obtained by decompressing the compressed geometry and, the rendering attributes of the current point cloud are mapped on the geometry of the temporary point cloud. For each block of the geometry of the temporary point cloud, a prediction mode is selected for the rendering attributes of the block by comparing the rendering attributes of the temporal prediction of current point cloud and the rendering attributes of the temporary point cloud. A prediction of the rendering attributes of the block is computed according to the selected prediction mode and a residue is obtained by subtracting the prediction from the rendering attributes of the temporary point cloud. The residue and the prediction mode are encoded in the data stream.

In an embodiment, the method further comprises computing an intra-frame prediction of the current point cloud. The selecting of a prediction mode for a block is further based on the intra-frame prediction. In another embodiment, a point cloud of the sequence and the temporary point cloud are structured as octrees, wherein blocks of the geometry of the temporary point clouds are nodes of the octree and wherein the selecting of a prediction mode is performed by layer of the octree. In another embodiment, the prediction modes are encoded using binary adaptive arithmetic coding.

The present principles also relate to a device comprising a memory associated with a processor configured for implementing the method above.

The present principles also relate to a method for decoding a sequence of point clouds. A point cloud of the sequence comprising a geometry and rendering attributes. The method comprises decoding a compressed geometry from the data stream and obtaining a temporary point cloud by decompressing the compressed geometry. Then, a temporal prediction of the temporary point cloud is obtained by motion-compensating the geometry and the rendering attributes of a previously decoded point cloud of the sequence. For each block of the geometry of the temporary point cloud, the method comprises decoding, from the bitstream, a prediction mode and a residue for the rendering attributes of the block. A prediction of the rendering attributes of the block is computed from the temporal prediction and according to the decoded prediction mode. The rendering attributes of the block are set by adding the residue to the prediction.

In an embodiment, the prediction of the rendering attributes of a block is further computed from on an intra-frame prediction of the temporary point cloud. In another embodiment, the current point cloud is structured as an octree, wherein blocks of the geometry of the current point clouds are nodes of the octree and wherein the selecting of a prediction mode is performed by layer of the octree. In another embodiment, the prediction modes are decoded using binary adaptive arithmetic coding.

The present principles also relate to a device comprising a memory associated with a processor configured for implementing the method above.

### 4. BRIEF DESCRIPTION OF DRAWINGS

The present disclosure will be better understood, and other specific features and advantages will emerge upon reading the following description, the description making reference to the annexed drawings wherein:

FIG. 1 illustrates a compression scheme for the rendering attributes of a dynamic point cloud, with motion-compensated inter-frame prediction combined with intra-frame prediction and associated with a hierarchical transform, according to the present principles;

FIG. 2 depicts a decoder scheme corresponding to the encoding scheme of FIG. 1, according to the present principles;

FIG. 3 shows an example architecture of a device which may be configured to implement a method for encoding or decoding a point cloud according to the present principles;

FIG. 4 shows an example of an embodiment of the syntax of a stream when the data are transmitted over a packet-based transmission protocol;

FIG. 5 illustrates a binary tree shown used to signal the prediction mode to the decoder according to the present principles;

FIG. 6 diagrammatically illustrates an octree (as a binary tree) with the last two highest levels (highest resolutions) being with inferred prediction according to the present principles.

### 5. DETAILED DESCRIPTION OF EMBODIMENTS

The present principles will be described more fully hereinafter with reference to the accompanying figures, in which examples of the present principles are shown. The present principles may, however, be embodied in many alternate forms and should not be construed as limited to the examples set forth herein. Accordingly, while the present principles are susceptible to various modifications and alternative forms, specific examples thereof are shown by way of examples in the drawings and will herein be described in detail. It should be understood, however, that there is no intent to limit the present principles to the particular forms disclosed, but on the contrary, the disclosure is to cover all modifications, equivalents, and alternatives falling within the spirit and scope of the present principles as defined by the claims.

The terminology used herein is for the purpose of describing particular examples only and is not intended to be limiting of the present principles. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to other element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the present principles.

Although some of the diagrams include arrows on communication paths to show a primary direction of communication, it is to be understood that communication may occur in the opposite direction to the depicted arrows.

Some examples are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Reference herein to “in accordance with an example” or “in an example” means that a particular feature, structure, or characteristic described in connection with the example can be included in at least one implementation of the present principles. The appearances of the phrase in accordance with an example” or “in an example” in various places in the specification are not necessarily all referring to the same example, nor are separate or alternative examples necessarily mutually exclusive of other examples.

Reference numerals appearing in the claims are by way of illustration only and shall have no limiting effect on the scope of the claims. While not explicitly described, the present examples and variants may be employed in any combination or sub-combination.

In a compression scheme of dense point cloud sequences, it is usual to compress the point cloud geometry (the 3D coordinates of the points) first, prior to rendering attributes. At the encoder side, a rendering attribute transfer (also called “recolouring”) is then performed to assign the colours of original point to the points of the decoded geometry. Indeed, in case of lossy geometry compression, the positions of original points may be displaced in the decoded point cloud. Then, rendering attributes are encoded on top of the decoded geometry, independently from the geometry encoding method. At decoder side, the geometry is first decoded and, the “reconstructed geometry” is available for rendering attributes decoding in a second step.

The present principles describe a compression scheme of dense point cloud sequences that take advantage of the temporal redundancy between successive point cloud frames in a sequence of dynamic point clouds to achieve enhanced compression performance for point cloud rendering attributes. Also, in a dynamic point cloud, not all object parts can be predicted from the previous point cloud frame. For example, an inter-frame prediction is difficult or even impossible to find for object parts that are not rigid, or with self-occlusions, all the more as when the motion model used for the temporal prediction is too simple (e.g. translational only). Some parts are more efficiently predicted in an intra mode, that is from already decoded parts of the current point cloud frame, either at a coarser resolution or from a causal decoding neighbourhood. According to the present principles, a hybrid intra/inter compression scheme is set.

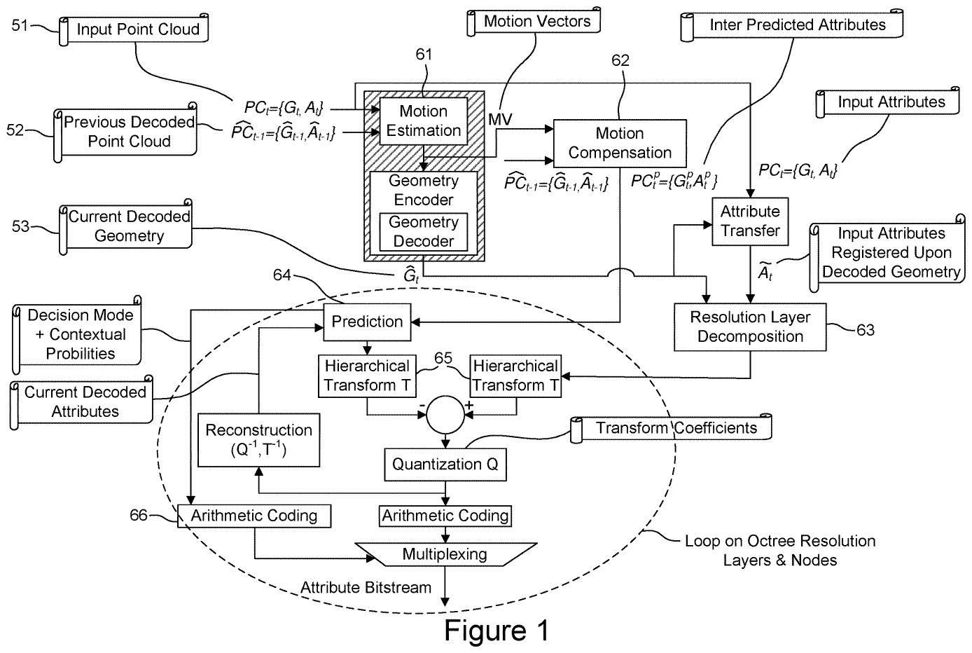

FIG. 1 illustrates a compression scheme for the rendering attributes of a dynamic point cloud, with motion-compensated inter-frame prediction combined with intra-frame prediction and associated with a hierarchical transform, according to the present principles. The encoder comprises different modules set up according to the present principles.

A block-based motion estimation 61 is performed between two successive point cloud frames, the current ‘target’ frame 51 (PCₜ) to encode and a previously decoded ‘reference’ frame 52 (PCₜ₋₁). Different motion estimation algorithms may be implemented to embody this module. It only assumes a block-based output motion format, providing a motion vector for each occupied cube (or ‘node’ in an octree-based representation) of the target point cloud frame, pointing to the matched location in the reference point cloud frame. A geometry encoder compresses the geometry, yielding a reconstructed (decoded) geometry. The geometry encoder takes advantage of 3D motion estimation to remove temporal redundancies and achieve enhanced geometry compression rate. Any geometry compression algorithm may embody this module. In case of lossy compression, the reconstructed geometry is different from the input geometry.

A motion-compensated inter-frame prediction 62 of rendering attributes of target point cloud frame is performed: points of decoded geometry 53 are displaced in the direction of the estimated motion vectors, and the corresponding decoded rendering attributes Âₜ₋₁ make the temporal prediction of current frame rendering attributes

$${A}_{t}^{p} ,$$

which is mapped onto the temporal prediction of geometry

$${G}_{t}^{p} .$$

A rendering attribute transfer processing block registers the input rendering attributes onto the points of the current decoded geometry Ĝₜ. In a variant, the temporally predicted rendering attributes are also registered upon the reconstructed geometry. In that case the input and temporally predicted rendering attributes share the same geometry. In this case, there is always a temporal rendering attribute predictor for the input rendering attributes.

The input frame is decomposed 63 into resolution layers, following an octree representation of the decoded geometry. From a root node with a single averaged attribute for the entire frame, down to leave nodes with the attributes of each point.

At each resolution layer, for each node of the octree, several prediction modes are evaluated 64. Several intra-frame predictors are computed making use of the already coded rendering attributes in the target point cloud, at a coarser resolution layer or in a causal encoding neighbourhood in current resolution layer. Inter-frame predictors originate from the inter-frame predicted point cloud frame. Additional predictors can also mix intra-frame and inter-frame already computed values. Eventually no prediction (the current rendering attribute value is directly coded) is also an option. The encoder decision module 66 selects the best prediction mode for the current node, according to a rate distortion optimization (RDO) criterion, jointly minimizing the prediction error and the bit rate. Coding modes are encoded using context-based arithmetic coding.

The rendering attributes of the child nodes of the current node (maximum eight if the node is fully occupied) are predicted with the chosen coding mode. Both predicted and input rendering attribute values of child nodes are input to the used hierarchical transform 65 (for example the RAHT transform) and the difference of predicted and input transform coefficients are quantized and entropy encoded with a binary arithmetic encoder.

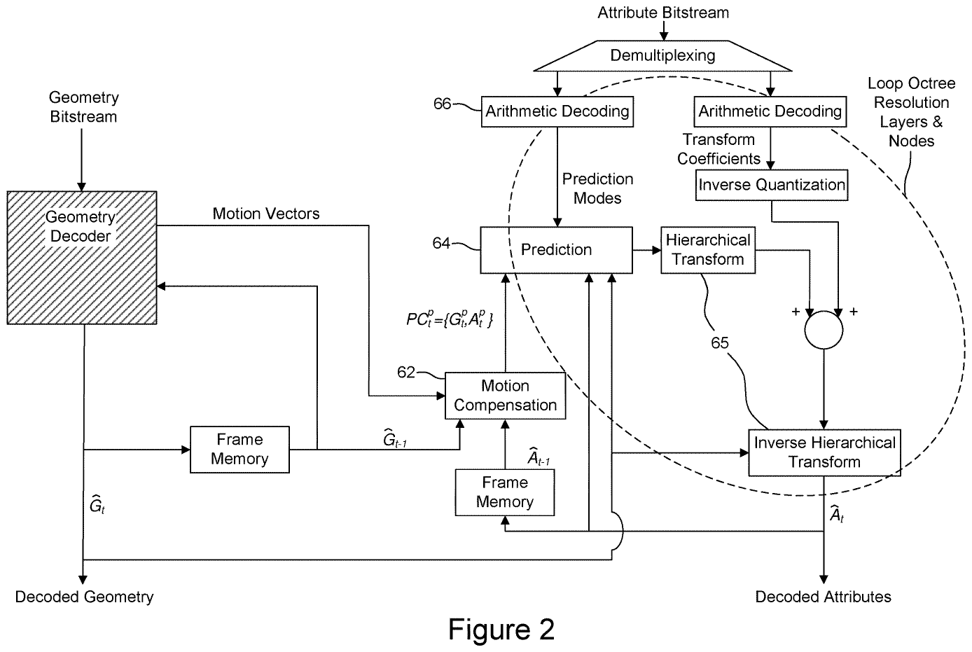

FIG. 2 depicts a decoder scheme corresponding to the encoding scheme of FIG. 1, according to the present principles. The same modules are used.

A non-exhaustive list of twenty-eight prediction modes to choose for each node is proposed herein:

| Nbr | ID | Description |
|---|---|---|
| 1 | Null | Direct encoding (no prediction) |
| 2 | Intra 0 | Intra-frame prediction using a first set of prediction weights |
| 3 | Intra 1 | Intra-frame prediction using a second set of prediction weights |
| 4 | Intra 2 | Intra-frame prediction using a third set of prediction weights |
| 5 | Intra 3 | Intra-frame prediction using a fourth set of prediction weights |
| 6 | Inter | Inter-frame prediction using the estimated motion vectors, without |
| | | refinement |
| 7 | Hybrid 0 | Hybrid (intra and inter) prediction using the first set of intra prediction |
| | | weights |
| 8 | Hybrid 1 | Hybrid (intra and inter) prediction using the second set of intra |
| | | prediction weights |
| 9 | Hybrid 2 | Hybrid (intra and inter) prediction using the third set of intra prediction |
| | | weights |
| 10 | Hybrid 3 | Hybrid (intra and inter) prediction using the fourth set of intra prediction |
| | | weights |
| 11 | Inter +x | Inter-frame prediction with a refinement +\vec{x} × Δ of the motion vector |
| 12 | Inter +x+y | Inter-frame prediction with a refinement (+\vec{x}+ \vec{y}) × Δ of the motion |
| | | vector |
| 13 | Inter +x-y | Inter-frame prediction with a refinement (+\vec{x}- \vec{y}) × Δ of the motion |
| | | vector |
| 14 | Inter -x | Inter-frame prediction with a refinement -\vec{x}× Δ for the motion vector |
| 15 | Inter -x-y | Inter-frame prediction with a refinement (-\vec{x}- \vec{y}) × Δ of the motion |
| | | vector |
| 16 | Inter -x+y | Inter-frame prediction with a refinement (-\vec{x} + \vec{y}) × Δ of the motion |
| | | vector |
| 17 | Inter +y | Inter-frame prediction with a refinement +\vec{y}× Δ of the motion vector |
| 18 | Inter +y+z | Inter-frame prediction with a refinement (+\vec{y}+ \vec{z}) × Δ of the motion |
| | | vector |
| 19 | Inter +y-z | Inter-frame prediction with a refinement (+\vec{y}- \vec{z}) × Δ of the motion |
| | | vector |
| 20 | Inter -y | Inter-frame prediction with a refinement \vec{y} × Δ of the motion vector |
| 21 | Inter -y-z | Inter-frame prediction with a refinement (-\vec{y} - \vec{z}) × Δ of the motion |
| | | vector |
| 22 | Inter -y+z | Inter-frame prediction with a refinement (-\vec{y} + \vec{z}) × Δ of the motion |
| | | vector |
| 23 | Inter +z | Inter-frame prediction with a refinement \vec{z} × Δ of the motion vector |
| 24 | Inter +z+x | Inter-frame prediction with a refinement (+\vec{z} - \vec{x}) × Δ of the motion |
| | | vector |
| 25 | Inter +z-X | Inter-frame prediction with a refinement (+\vec{z} - \vec{x}) × Δ of the motion |
| | | vector |
| 26 | Inter -Z | Inter-frame prediction with a refinement -\vec{z} × Δ of the motion vector |
| 27 | Inter -z-x | Inter-frame prediction with a refinement (-\vec{z} - \vec{x}) × Δ of the motion |
| | | vector |
| 28 | Inter -z+x | Inter-frame prediction with a refinement (-\vec{z} + \vec{x}) × Δ of the motion |
| | | vector |

### Intra-Frame Prediction Modes

In this type of prediction modes, the child attribute is predicted by a weighted average of neighbouring nodes attributes on the previous level (‘parents’ and ‘uncles’), and the rendering attributes of the already encoded/decoded neighbouring child nodes at same level (‘cousins’). The weights are optimized at encoding stage on a given point cloud. Several sets of weights can be pre-computed, hard-coded and transmitted to the decoder. In the non-exhaustive list above, four sets are proposed for intra-frame prediction (modes 2 to 5).

### Inter-Frame Prediction Mode

One mode of this type is proposed in the list above (mode 6). The predictor is the rendering attribute of the corresponding node in motion compensated temporal prediction point cloud frame

$${A}_{t}^{p} .$$

### Hybrid Intra-Inter Prediction Modes

Four modes of this type are proposed in the list above (modes 7 to 10). In the intra-frame prediction modes, not all the neighbouring nodes at same level are used in the weighted prediction, but only those already decoded in a causal decoding neighbourhood. This hybrid intra-inter modes replaces the missing ‘cousins’ by their counterpart at same location in the temporally predicted point cloud frame.

Inter-Frame Prediction Modes with Motion Vector Refinement

The 3D motion vectors optimized for predicting the geometry and used within the hybrid inter/intra geometry encoding process not always provide the optimal prediction of rendering attributes (limitation of the motion model in case of non-rigid deformations, object self-occlusions, illumination effects and light changes, etc.). To overcome the limitation of the inter-frame prediction mode (mode 6), ±Δ variations around the points of the temporal prediction point cloud frame are used to provide alternative temporal predictions of the rendering attributes. In the non-exhaustive list above, eighteen increments are tested (modes 11 to 28). The value of Δ equals to ½ or ¼ the size of a node along axis x or y or z. Therefore, the value of Δ changes at every level, but is constant for all nodes in a given level. This pattern may be refined. For example, allowing Δ increments along x, y and z simultaneously, would yield eight additional prediction modes.

The encoder selects a prediction mode for each octree node. First, for each available prediction mode a difference between transformed coefficients of the prediction and transformed coefficients of the current rendering attribute to encode is computed. This difference is quantized and the number of bits to encode its coefficients is estimated.

The rendering attributes are then reconstructed by dequantizing the quantized coefficients difference, re-adding them to the prediction, and inverse transform. The mean squared error (MSE) for the reconstructed rendering attributes based on each prediction mode is computed.

The prediction mode which jointly minimizes the prediction error and the transmission rate, using cost function MSE+λRate, is chosen, where Rate is the average number of bits per child necessary to encode the difference of quantized coefficients and to signal the prediction mode.

The weighting coefficient A is determined according to equation Eq1:

$$λ = 4 \times \frac{{μ}_{M S E}}{{μ}_{R a t e}} \qquad Eq1$$

where μ_{MSE} is the average MSE for the null prediction and μ_{Rate} is the average number of bits per child to encode the null prediction. These averages are learned during the encoding according to equations Eq2 and Eq3, where i is the index of the current encoding node:

$${μ}_{M S {E}_{i + 1}} = {μ}_{M S {E}_{i}} \times ( 1 - {α}_{i} ) + M S {E}_{i} \times {α}_{i} \qquad Eq2$$

$${μ}_{R a t {e}_{i + 1}} = {μ}_{R a t {e}_{i}} \times ( 1 - {α}_{i} ) + R a t {e}_{i} \times {α}_{i} \qquad Eq3$$

$$Where :$$

$${α}_{i + 1} = {α}_{i} \times 0.98 + 0.001 \times 0.02 \qquad Eq4$$

The values are initialized according to equation Eq5:

$${α}_{0} = 1 , {μ}_{M S {E}_{0}} = 0 , {μ}_{R a t {e}_{0}} = 1 \qquad Eq5$$

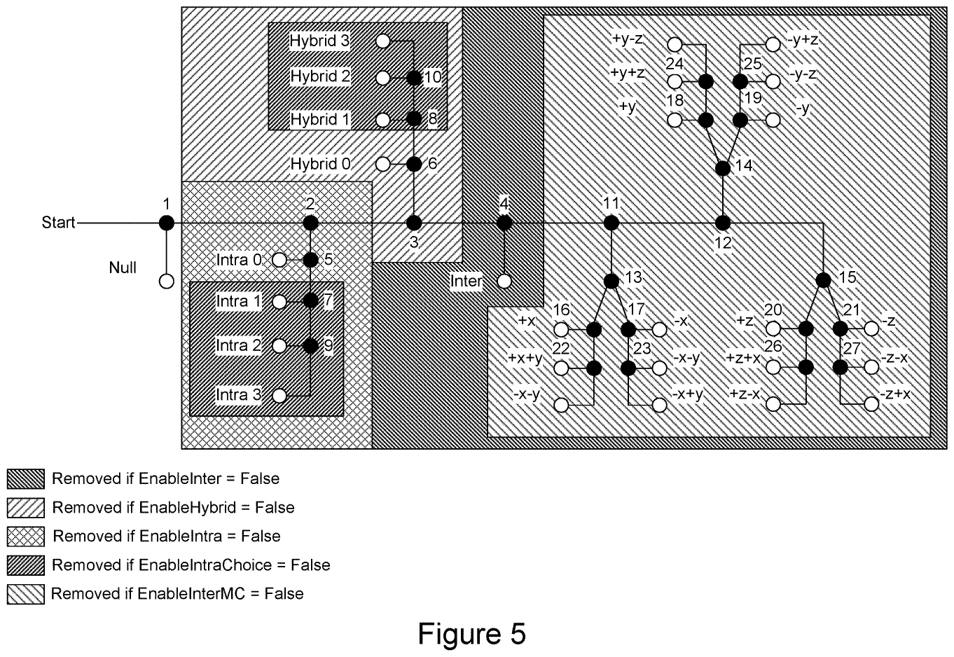

FIG. 5 illustrates a binary tree shown used to signal the prediction mode to the decoder according to the present principles. Every leaf of this tree corresponds to one of the twenty-eight prediction modes of the non-exhaustive list above. On the first hand, the encoder goes through the tree until arriving to the leaf corresponding to the selected prediction mode. At each tree node it passes through, it signals which direction to follow by a binary flag that is entropy coded into the bitstream with an arithmetic coder. On the other hand, the decoder goes through the tree, reading a flag from the bitstream whenever it is at a tree node to decode which direction to follow, until it arrives to a tree leaf that corresponds to the decoded prediction mode.

The flag is encoded using binary arithmetic coding with a given probability for the flag to be true or false. The probability is adaptative and depends on two contexts, ctxMode and ctxLevel, which are integers starting at 0 that represent different scenarios. The probability also depends on the node in the tree:
Node 1: is used the probability isNull[ctxMode]. Is encoded a flag true if the chosen prediction is null with a probability (1−isNull[ctxMode]) or a flag false otherwise with probability isNull[ctxMode].
Node 2: is used the probability isIntra[ctxMode]. Is encoded a flag true if the chosen prediction is one of the intra mode (Intra 0 to 3) with a probability (1−isIntra[ctxMode]) or a flag false otherwise with probability isIntra[ctxMode].
Node 3: is used the probability isInter[ctxMode]. Is encoded a flag true if the chosen prediction is one of the inter modes with a probability (1−isInter[ctxMode]) or a flag false otherwise with probability isInter[ctxMode].
Node 4: is used the probability motionCompensation[ctxLevel][0]. Is encoded a flag true if the chosen prediction is inter without motion compensation refinement with a probability (1−motionCompensation[ctxLevel][0]) or a flag false otherwise with probability motionCompensation[ctxLevel][0].
Node 5 and 6: is used the probability intraChoice[ctxLevel][0]. Is encoded a flag true if the chosen prediction is Intra 0 or Hybrid 0 with probability (1−intraChoice[ctxLevel][0]) or a flag false otherwise with probability intraChoice[ctxLevel][0].
Node 7 and 8: is used the probability intraChoice[ctxLevel][1]. Is encoded a flag true if the chosen prediction is Intra 1 or Hybrid 1 with probability (1−intraChoice[ctxLevel][1]) or a flag false otherwise with probability intraChoice[ctxLevel][1].
Node 9 and 10: is used the probability intraChoice[ctxLevel][2]. Is encoded a flag true if the chosen prediction is Intra 2 or Hybrid 2 with probability (1−intraChoice[ctxLevel][2]) or a flag false otherwise with probability intraChoice[ctxLevel][2].
Node 11: is used the probability motionCompensation[ctxLevel][1]. Is encoded a flag true if the chosen prediction is inter with motion compensation refinement +x, +x+y, +x−y, −x, −x−y or −x+y with a probability (1−motionCompesation[ctxLevel][1]) or a flag false otherwise with probability motionCompensation[ctxLevel][1].
Node 12: is used the probability motionCompensation[ctxLevel][2]. Is encoded a flag true if the chosen prediction is inter with motion compensation refinement +y, +y+z, +y−z, −y, −y−z or −y+z with a probability (1−motionCompesation[ctxLevel][2]) or a flag false otherwise with probability motionCompensation[ctxLevel][3].
Node 13: is used the probability motionCompensation[ctxLevel][3]. Is encoded a flag true if the chosen prediction is inter with motion compensation refinement −x, −x−y or −x+y with a probability (1−motionCompesation[ctxLevel][3]) or a flag false otherwise with probability motionCompensation[ctxLevel][3].
Node 14: is used the probability motionCompensation[ctxLevel][4]. Is encoded a flag true if the chosen prediction is inter with motion compensation refinement −y, −y−z or −y+z with a probability (1−motionCompesation[ctxLevel][4]) or a flag false otherwise with probability motionCompensation[ctxLevel][4].
Node 15: is used the probability motionCompensation[ctxLevel][5]. Is encoded a flag true if the chosen prediction is inter with motion compensation refinement −z, −z−x or −z+x with a probability (1−motionCompesation[ctxLevel][5]) or a flag false otherwise with probability motionCompensation[ctxLevel][5].
Node 16: is used the probability motionCompensation[ctxLevel][6]. Is encoded a flag true if the chosen prediction is inter with motion compensation refinement +x with a probability (1−motionCompensation[ctxLevel][6]) or a flag false otherwise with probability motionCompensation[ctxLevel][6].
Node 17: is used the probability motionCompensation[ctxLevel][7]. Is encoded a flag true if the chosen prediction is inter with motion compensation refinement +y with a probability (1−motionCompensation[ctxLevel][7]) or a flag false otherwise with probability motionCompensation[ctxLevel][7].
Node 18: is used the probability motionCompensation[ctxLevel][8]. Is encoded a flag true if the chosen prediction is inter with motion compensation refinement +z with a probability (1−motionCompesation[ctxLevel][8]) or a flag false otherwise with probability motionCompesation[ctxLevel][8].
Node 19: is used the probability motionCompensation[ctxLevel][9]. Is encoded a flag true if the chosen prediction is inter with motion compensation refinement −x with a probability (1−motionCompensation[ctxLevel][9]) or a flag false otherwise with probability motionCompensation[ctxLevel][9].
Node 20: is used the probability motionCompensation[ctxLevel][10]. Is encoded a flag true if the chosen prediction is inter with motion compensation refinement −y with a probability (1−motionCompensation[ctxLevel][10]) or a flag false otherwise with probability motionCompensation[ctxLevel][10].
Node 21: is used the probability motionCompensation[ctxLevel][11]. Is encoded a flag true if the chosen prediction is inter with motion compensation refinement −z with a probability (1−motionCompensation[ctxLevel][11]) or a flag false otherwise with probability motionCompensation[ctxLevel][11].
Node 22: is used the probability motionCompensation[ctxLevel][12]. Is encoded a flag true if the chosen prediction is inter with motion compensation refinement +x+y with a probability (1−motionCompensation[ctxLevel][12]) or a flag false otherwise with probability motionCompensation[ctxLevel][12].
Node 23: is used the probability motionCompensation[ctxLevel][13]. Is encoded a flag true if the chosen prediction is inter with motion compensation refinement −x−y with a probability (1−motionCompensation[ctxLevel][13]) or a flag false otherwise with probability motionCompensation[ctxLevel][13].
Node 24: is used the probability motionCompensation[ctxLevel][14]. Is encoded a flag true if the chosen prediction is inter with motion compensation refinement +y+z with a probability (1−motionCompensation[ctxLevel][14]) or a flag false otherwise with probability motionCompensation[ctxLevel][14].
Node 25: is used the probability motionCompensation[ctxLevel][15]. Is encoded a flag true if the chosen prediction is inter with motion compensation refinement −y-z with a probability (1−motionCompensation[ctxLevel][15]) or a flag false otherwise with probability motionCompensation[ctxLevel][15].
Node 26: is used the probability motionCompensation[ctxLevel][16]. Is encoded a flag true if the chosen prediction is inter with motion compensation refinement +z+x with a probability (1−motionCompensation[ctxLevel][16]) or a flag false otherwise with probability motionCompensation[ctxLevel][16].
Node 27: is used the probability motionCompensation[ctxLevel][17]. Is encoded a flag true if the chosen prediction is inter with motion compensation refinement −z-x with a probability (1−motionCompesation[ctxLevel][17]) or a flag false otherwise with probability motionCompensation[ctxLevel][17].

The probabilities are updated on-the-fly during encoding, at any time they are used to encode a flag. If the probability is used to encode a true flag, the value of the probability is decreased. If it is used to encode a false flag, the value of the probability is increased.

There are 3×NbCtxtMode+21×NbCtxLevel such probabilities to maintain, associated with node flags and depending on contexts, where NbCtxMode is the number of contexts of the first type and NbCtxLevel is the number of contexts of the second type, which are detailed below.

The signalling of some prediction modes can be removed from the signalling tree of FIG. 5 depending on the following control flags:
enableInter: is set to false when an intra frame is encoded (frame encoded with intra-frame prediction only, without any reference to other frame in the sequence) because the inter prediction will never be used.
enableHybrid: is set to false when an intra frame is encoded or when the user choses to never use hybrid mode.
enableIntra: is set to false when the decision flow (specific to the RAHT transform) predicts that the intra-frame prediction will result in reduction of encoding performance.
enableIntraChoice: is set by the user and is used to enable/disable the choices of different weights for intra and hybrid predictions.
enableInterMC: is set by the user to enable/disable refined motion compensated prediction mode.

When some of these flags are set to false, the decision tree is reduced. When removing modes from the signalling trees, some nodes may become degenerated. If there is only one single path that can be followed from a node, it is not encoded/decoded a flag for it.

The context ctxMode combines a set of contextual information available at the encoder and decoder. There are 216 such contexts, which are indexed according to equation Eq6.

$$Eq6$$

$$ctxMode = [ Enabled prediction flags ] + [ Parent prediction mode ] \times 3 + [ Neighbours prediction mode ] \times 3 \times 3 + [ Number of childern ] \times 4 \times 3 \times 3 + [ MSE of the inter prediction DC value ] \times 3 \times 4 \times 3 \times 3$$

Where:
[Enable prediction flags]: The enableIntra flag defined in previous sub-section, when false, predicts that using intra-frame prediction is worse than not using it. A second interCompleteness flag related to inter-frame prediction is defined, which is set to true when the inter-frame prediction provides a prediction for all the child nodes of the current node. This flag is always false for intra frames. These two flags are combined into one as follows:

if both of them are true, then [Enable prediction flags] = 2
otherwise, if enableIntra is true, then [Enable prediction flags] = 1
otherwise [Enable prediction flags] = 0

[Parent prediction mode]: Depends on the prediction mode that was chosen for the parent mode:

```
  if the parent node used one of the inter prediction modes, then [Parent prediction mode]
= 2
  otherwise, if the parent mode used one of the intra or hybrid prediction modes, then
[Parent prediction mode] = 1
  otherwise [Parent prediction mode] = 0
```

[Neighbours prediction mode]: A voting process between the neighbouring uncle nodes and already decoded cousin nodes is performed to determine which prediction mode was the most used among them. There are 4 categories: null, intra (comprising all intra modes), hybrid (comprising all hybrid modes), and inter (comprising all inter modes). A voting counter is created for each category that is incremented with the vote of every uncle and already decoded cousin nodes. An uncle node has a vote with weight 1 and an already decoded cousin node has a vote with weight 3. Then:

```
  if the counter for the inter category is the highest, then [Neighbours prediction mode]
= 3
  if the counter for the intra category is the highest, then [Neighbours prediction mode]
= 2
  if the counter for the null category is the highest, then [Neighbours prediction mode] =
1
  otherwise, [Neigbors prediction mode] = 0
```

[Number of children]:

if the node has more than 5 children, then [Number of children] = 2
otherwise, if the node has more than 3 children, then [Number of children] = 1
otherwise [Number of children] = 0

[MSE of the inter prediction DC value]: The DC value of the inter (without motion refinement) predicted rendering attributes of a node is compared with the DC value of the parent node, as this information is available at both encoder and decoder. The mean squared error (MSE) between the prediction DC value and the node DC value is computed:
   if the MSE is above a threshold (known by both encoder and decoder, for example a fixed value or a value set at encoder stage and transmitted in the high level syntax of the bitstream), then [MSE of the inter prediction DC value]=1
   otherwise, [MSE of the inter prediction DC value]=0

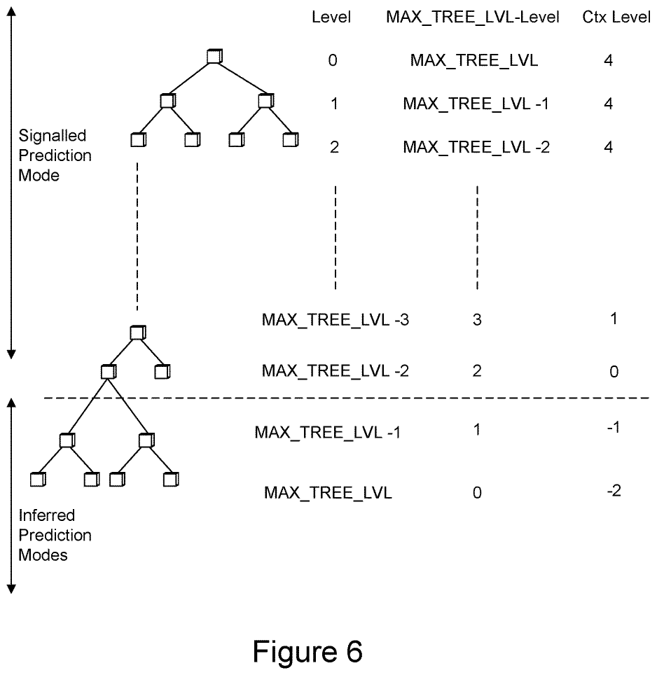

FIG. 6 diagrammatically illustrates an octree (as a binary tree) with the last two highest levels (highest resolutions) being with inferred prediction according to the present principles. An octree is a multiresolution representation of geometry, organized into levels. The root node is at level 0, its child nodes at level 1, and so on until the leaves at MAX TREE LVL. This level value is used to create the ctxLevel context according to equation Eq7:

$$ctxLevel = Min ( ( MM\_TREE \_LVL - level ) - NBR\_INFER \_LVL , \qquad Eq7$$

MAX_CTX_LVL) where NBR_INFER_LVL is a value defined by the user (and transmitted in the high-level syntax of the bitstream). The value of ctxLevel is capped at MAX_CTX_LVL.

For negative values of ctxLevel, the encoder does not signal the selected prediction mode and an inferred mode is used. The prediction mode for the nodes is not signalled (their cost would become prohibitive at such highest resolution levels with a large number of nodes) but inferred from contextual information available at both encoder and decoder side. In a first embodiment, the prediction mode inference is performed as follows:
if the interCompleteness flag is true (one inter prediction value for all the child nodes) and the parent node was predicted using one of the inter prediction modes, then the inter prediction (without MC refinement in this case) is used;
otherwise, if the enableIntra flag is true, the intra 0 prediction mode is used;
otherwise, the null prediction mode is used.

In a second embodiment, the prediction mode inference is performed as follows (no inter prediction is used):
if the enableIntra flag is true, the intra 0 prediction mode is used;
otherwise, the null prediction mode is used.

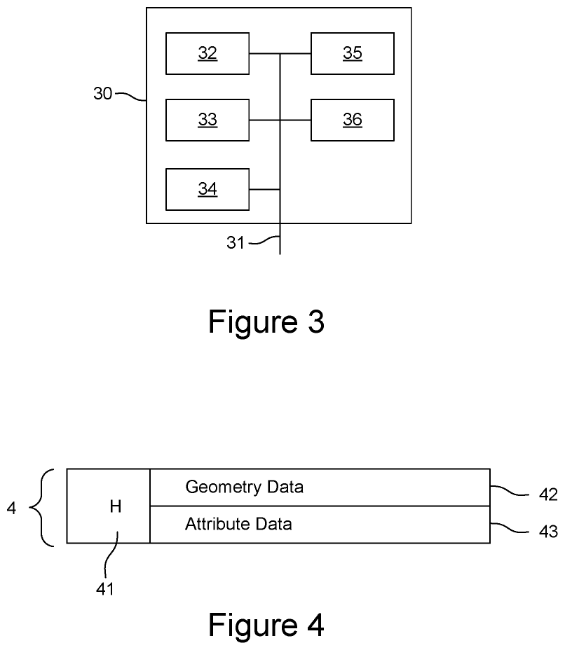

FIG. 3 shows an example architecture of a device 30 which may be configured to implement a method for encoding or decoding a sequence of point clouds according to the present principles. An encoder may implement the method described in relation to FIG. 1 and a decoder may implement the method described in relation to FIG. 2. Alternatively, each circuit of the encoder and/or the decoder may be a device according to the architecture of FIG. 3, linked together, for instance, via their bus 31 and/or via I/O interface 36. Device 30 comprises following elements that are linked together by a data and address bus 31:
a microprocessor 32 (or CPU), which is, for example, a DSP (or Digital Signal Processor);
a ROM (or Read Only Memory) 33;
a RAM (or Random Access Memory) 34;
a storage interface 35;
an I/O interface 36 for reception of data to transmit, from an application; and
a power supply, e.g. a battery.

In accordance with an example, the power supply is external to the device. In each of mentioned memory, the word «register» used in the specification may correspond to area of small capacity (some bits) or to very large area (e.g. a whole program or large amount of received or decoded data). The ROM 33 comprises at least a program and parameters. The ROM 33 may store algorithms and instructions to perform techniques in accordance with present principles. When switched on, the CPU 32 uploads the program in the RAM and executes the corresponding instructions.

The RAM 34 comprises, in a register, the program executed by the CPU 32 and uploaded after switch-on of the device 30, input data in a register, intermediate data in different states of the method in a register, and other variables used for the execution of the method in a register.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

In accordance with examples, the device 30 belongs to a set comprising:
a mobile device;
a communication device;
a game device;
a tablet (or tablet computer);
a laptop;
a still picture camera;
a video camera;
an encoding chip;
a server (e.g. a broadcast server, a video-on-demand server or a web server).

FIG. 4 shows an example of an embodiment of the syntax of a stream when the data are transmitted over a packet-based transmission protocol. FIG. 4 shows an example structure 4 of a stream encoding a sequence of point clouds according to the present principle. The structure consists in a container which organizes the stream in independent elements of syntax. The structure may comprise a header part 41 which is a set of data common to every syntax element of the stream. For example, the header part comprises some of metadata about syntax elements, describing the nature and the role of each of them. The structure comprises a payload comprising an element of syntax 42 and at least one element of syntax 43 (there may be an element of syntax 43 for each type of attribute data, for instance one for the color, one for the reflectance, one for the normal vectors, etc.). Syntax element 42 comprises data representative of the geometry of the point cloud, that is a series of bits representative of the octree. Element of syntax 43 is a part of the payload of the data stream and may comprise data encoding the attribute values as represented in the point cloud or as residual data (called residue) for a prediction step.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, Smartphones, tablets, computers, mobile phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding, data decoding, view generation, texture processing, and other processing of images and related texture information and/or depth information. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

Amendments to and listing of the claims:

1. A method for encoding, in a data stream, a sequence of point clouds, a point cloud of the sequence comprising a geometry and rendering attributes, the method comprising, for a current frame:
obtaining a temporal prediction of a current point cloud by motion-compensating the geometry and the rendering attributes of a previous frame of the sequence;
compressing the geometry of the current point cloud, encoding the compressed geometry in the data stream and obtaining a temporary point cloud by decompressing the compressed geometry;
mapping the rendering attributes of the current point cloud on the geometry of the temporary point cloud; and
for each block of the geometry of the temporary point cloud, selecting a prediction mode for the rendering attributes of the block by comparing the rendering attributes of the temporal prediction of the current point cloud and the rendering attributes of the temporary point cloud; computing a prediction of the rendering attributes of the block according to the selected prediction mode and obtaining a residue by subtracting the prediction from the rendering attributes of the temporary point cloud and encoding the residue and the prediction mode in the data stream.

2. The method of claim 1, further comprising computing an intra-frame prediction of the current point cloud, wherein selecting a prediction mode for a block is further based on the intra-frame prediction.

3. The method of claim 1, wherein a point cloud of the sequence and the temporary point cloud are structured as octrees, wherein blocks of the geometry of the temporary point clouds are nodes of the octree and wherein selecting a prediction mode is performed by layer of the octree.

4. The method of claim 1, wherein the prediction modes are encoded using binary adaptive arithmetic coding.

5. A device for encoding, in a data stream, a sequence of point clouds, a point cloud of the sequence comprising a geometry and rendering attributes, the device comprising a processor associated with a memory, the processor being configured for, for a current frame:
obtaining a temporal prediction of a current point cloud by motion-compensating the geometry and the rendering attributes of a previous frame of the sequence;
compressing the geometry of the current point cloud, encoding the compressed geometry in the data stream and obtaining a temporary point cloud by decompressing the compressed geometry;
mapping the rendering attributes of the current point cloud on the geometry of the temporary point cloud; and
for each block of the geometry of the temporary point cloud, selecting a prediction mode for the rendering attributes of the block by comparing the rendering attributes of the temporal prediction of the current point cloud and the rendering attributes of the temporary point cloud; computing a prediction of the rendering attributes of the block according to the selected prediction mode and obtaining a residue by subtracting the prediction from the rendering attributes of the temporary point cloud and encoding the residue and the prediction mode in the data stream.

6. The device of claim 5, wherein the processor is further configured for computing an intra-frame prediction of the current point cloud and wherein selecting a prediction mode for a block is further based on the intra-frame prediction.

7. The device of claim 5, wherein a point cloud of the sequence and the temporary point cloud are structured as octrees, wherein blocks of the geometry of the temporary point clouds are nodes of the octree and wherein selecting a prediction mode is performed by layer of the octree.

8. The device of claim 5, wherein the prediction modes are encoded using binary adaptive arithmetic coding.

9. A method for decoding a sequence of point clouds, a point cloud of the sequence comprising a geometry and rendering attributes, the method comprising:
decoding a compressed geometry from a data stream and obtaining a temporary point cloud by decompressing the compressed geometry;
obtaining a temporal prediction of the temporary point cloud by motion-compensating the geometry and the rendering attributes of a previously decoded point cloud of the sequence;
for each block of the geometry of the temporary point cloud, decoding, from the data stream, a prediction mode and a residue for the rendering attributes of the block;
computing a prediction of the rendering attributes of the block from the temporal prediction and according to the prediction mode; and setting the rendering attributes of the block by adding the residue to the prediction.

10. The method of claim 9, wherein the prediction of the rendering attributes of a block is further computed from an intra-frame prediction of the temporary point cloud.

11. The method of claim 9, wherein the current point cloud is structured as an octree, wherein blocks of the geometry of the current point clouds are nodes of the octree and wherein decoding a prediction mode is performed by a layer of the octree.

12. The method of claim 9, wherein the prediction modes are decoded using binary adaptive arithmetic coding.

13. A device for decoding a sequence of point clouds, a point cloud of the sequence comprising a geometry and rendering attributes, the device comprising a processor associated with a memory, the processor being configured for:
decoding a compressed geometry from a data stream and obtaining a temporary point cloud by decompressing the compressed geometry;
obtaining a temporal prediction of the temporary point cloud by motion-compensating the geometry and the rendering attributes of a previously decoded point cloud of the sequence;
for each block of the geometry of the temporary point cloud, decoding, from the data stream, a prediction mode and a residue for the rendering attributes of the block; computing a prediction of the rendering attributes of the block from the temporal prediction and according to the prediction mode; and setting the rendering attributes of the block by adding the residue to the prediction.

14. The device of claim 13, wherein the prediction of the rendering attributes of a block is further computed from an intra-frame prediction of the temporary point cloud.

15. The device of claim 13, wherein the point cloud is structured as an octree, wherein blocks of the geometry of the temporary point clouds are nodes of the octree and wherein decoding a prediction mode is performed by a layer of the octree.

16. The device of claim 13, wherein the prediction modes are decoded using binary adaptive arithmetic coding.
